(19) United States
(12) Patent Application Publication
(10) Pub. No.: US 2006/0064906 A1
(43) Pub. Date: Mar. 30, 2006

(54) Greeting card jacket

(76) Inventor: Beverly Flemons, Belleville, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/238,878

(22) Filed: Sep. 29, 2005

Related U.S. Application Data
(60) Provisional application No. 60/614,205, filed on Sep. 29, 2004.

(51) Int. Cl. G09F 1/00

(52) U.S. Cl. 40/124.06

(57) ABSTRACT

A greeting card jacket may include a body having an exterior surface, an interior surface that defines a pocket and a flap for closing the pocket. A handle may be secured to the body for carrying or otherwise supporting the jacket. The exterior surface of the body may also include a covering and ornamentation that may cause the jacket to have the outward appearance of a wrapped gift. A greeting card may be positioned in the pocket and a stand may be provided to support and display the jacket.

### CROSS-REFERENCE TO RELATED APPLICATIONS

The present application claims priority of U.S. Provisional Patent Application Ser. No. 60/614,205 filed Sep. 29, 2004, which is incorporated herein by reference.

### BACKGROUND OF THE INVENTION

1. Field of the Invention

The present invention is directed to a greeting card jacket. More specifically, the invention is directed to a container or pouch for holding or presenting a greeting card that may include external ornamentation and that may also be positioned or fixed on an associated stand for display.

2. Reference to Related Art

A gift card envelope as disclosed by U.S. Patent Application Publication No. U.S. 2002/0100797 may include one or more panels configured to form a pocket. Accent apertures may also be provided to highlight areas of a card that is positioned in the pocket. The envelope may also include a closure mechanism to ensure that any associated gift or credit card is contained in the envelope.

Another type of container was described by U.S. Pat. No. 1,579,198, which discloses a handbag construction. Specifically, this reference describes a body constructed of leather or another flexible material. A cover may also be included that is integral to the body. The cover may feature a closure for use in securing the cover to the body. Further, a handle may be disposed across the top of the body for ease in carrying the bag.

U.S. Pat. No. 2,157,327 disclosed another type of handbag. The handbag includes a pocket that may receive a stiffening insert or be provided with other means to stiffen the flap closure. Further, an inner side of the closure flap pocket may include an extension that projects down adjacent the bag.

Finally, U.S. Pat. No. 3,669,169 disclosed a lady's handbag having an elongated body with triangular shaped side panels. The handbag also includes connector members that facilitate the connection of a carrying handle and ornamental members to the handbag.

### SUMMARY OF THE INVENTION

A greeting card jacket that may be positioned or displayed on an associated stand and contain a greeting card may include a body having an exterior surface, an interior surface that defines a pocket, and a flap or closure panel for closing the pocket. A handle may be secured to the body for carrying or otherwise supporting the jacket. Further, the exterior surface of the body may include a decorative or textured surface cover or layer and ornamentation. The surface cover or the ornamentation may give the jacket the outward appearance of a wrapped gift.

### BRIEF DESCRIPTION OF THE DRAWINGS

Reference will now be made to the drawings, wherein like reference numerals refer to like parts throughout, and wherein:

FIG. 1 is a right side front perspective view of an embodiment of a greeting card jacket constructed in accord with the present invention;

FIG. 2 is a front view of the greeting card jacket shown in FIG. 1 positioned on a stand;

FIG. 3 is a planar side view of the greeting card jacket shown in FIG. 1 positioned on a stand;

FIG. 4 is a front planar view of the greeting card jacket of FIG. 1 with the flap of the greeting card jacket in the open position;

FIG. 5 is a front planar view of another embodiment of a greeting card jacket constructed in accord with the present invention;

FIG. 6 is a front planar view of the greeting card jacket shown in FIG. 5 with the flap shown in the open position; and

FIG. 7 is a side planar view of the greeting card jacket shown in FIG. 5.

### DETAILED DESCRIPTION

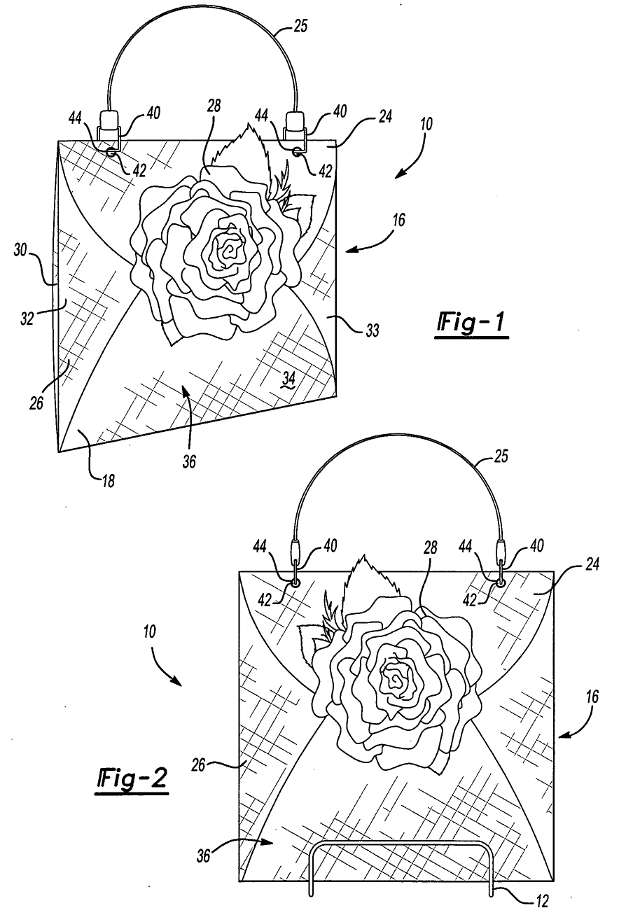

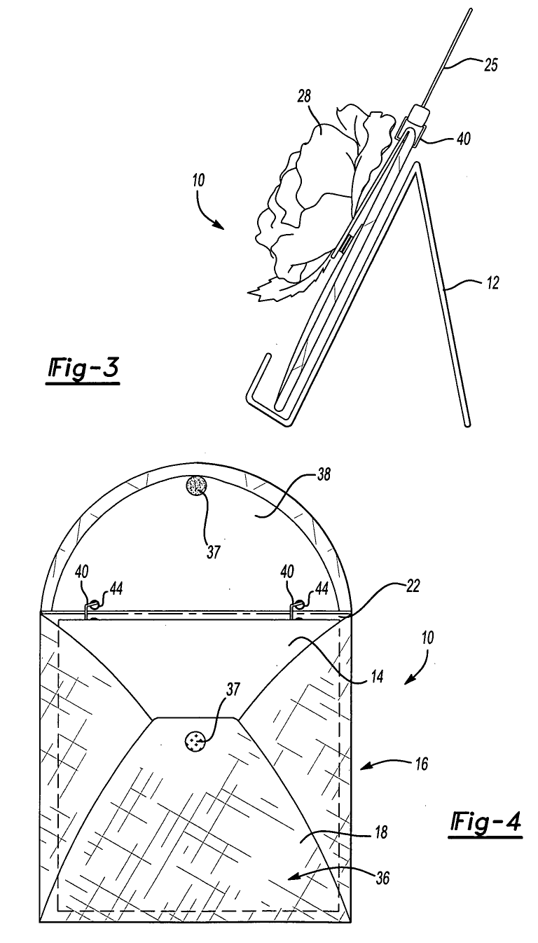

Referring now to FIGS. 1-4, a greeting card jacket 10 that may be positioned or displayed on an associated stand 12 and contain a greeting card 14 may include a body 16 having an exterior surface 18, an interior surface 20 that defines a pocket 22, and a flap 24 or closure panel for closing the pocket 22. A handle 25 may be secured to the body 16 for carrying or otherwise supporting the jacket 10. Further, the exterior surface 20 of the body 16 may include a decorative or textured surface cover 26 or layer and ornamentation 28. The surface cover 26 or the ornamentation 28 may give the jacket 10 the outward appearance of a wrapped greeting. The greeting card 14 may include any manner of greeting card, greeting certificate, gift card, gift certificate, currency, a check, a money order, bond, stock or other negotiable instrument or any like device. As shown, the stand 12 is a metal wire stand. However, the stand may also be constructed of a metal, metal alloy, wood or a polymer.

Still referring to FIGS. 1-4, the body 16 of the greeting card jacket 10 may be constructed of a single substrate material having predetermined folded panel sections. Alternatively, the body 16 may be constructed of one or more separate materials that are secured together by adhesive, stitching or like method. As shown in FIGS. 1-4, the jacket 10 may be formed of a one-piece substrate of a semi-rigid material, such as cardboard, card or heavy stock paper. The body 16 of the jacket 10 may include a generally square or rectangular shaped rear panel 30. A first 32 and a second 33 side and a front panel 34 may extend from the rear panel 30 and folded to create, with the rear panel 30, the pocket 22 and a front wall 36 for the body 16. The flap 24 may extend from the rear panel 30 along a side opposite the front panel 34.

Still referring to FIGS. 1-4 and as best shown in FIG. 4, a fastener 37, such as a snap, VELCRO®, button, slot and tab, or adhesive fastener may be positioned on an interior surface 38 of the flap 24 and to the front wall 36. Accordingly, the fastener 37 may operate to secure the flap 24 to the front wall 36 of the body 16 and enclose the pocket 22.

Still referring to FIGS. 1-4, the handle 25 may be secured to the body 16 on brackets 40 that extend through apertures 42 positioned along a fold of the rear panel 30 and the flap 24. Grommets 44 may also be positioned in the apertures 42 for additional strength and to resist tearing of the substrate material of the body 16 at the apertures 42.

Still referring to FIGS. 1-4, the exterior surface 20 of the body 16 may be covered with a decorative or textured cover 24. For example, the body 16 may be covered with a textured or plain paper, a fabric, stickers or decals, or may be painted. Further, one or more items of ornamentation 28 such as a ribbon, bow or artificial flower may be positioned on the exterior surface 20 such that the jacket 10 assumes the outward appearance of a wrapped greeting or present.

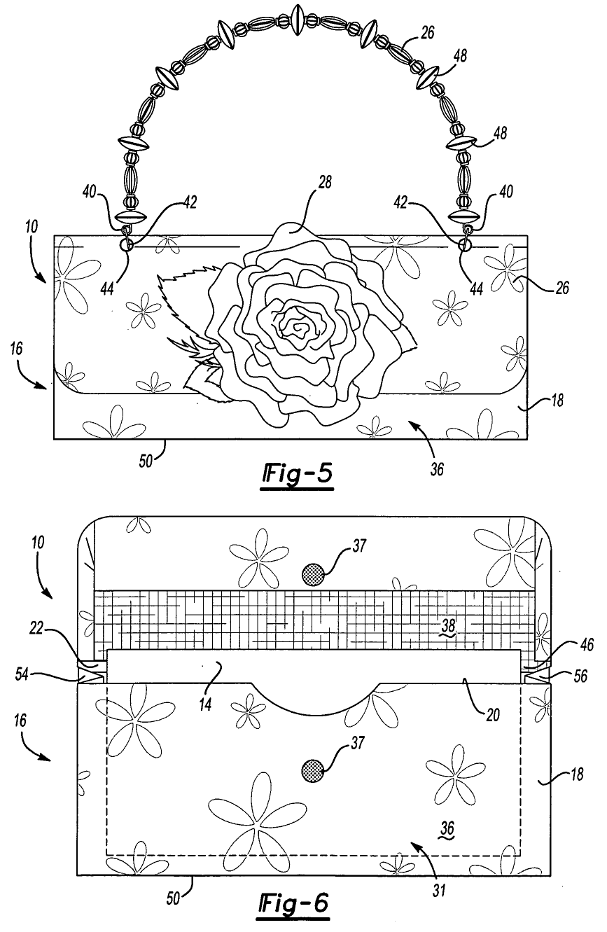

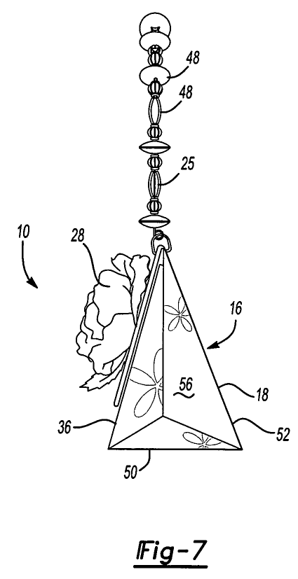

Referring now to FIGS. 5-7, another embodiment of a greeting card jacket 10 may contain a greeting card 14 and may include a body 16 having an exterior surface 18, an interior surface 20 that defines a pocket 22, and a flap 24 or closure panel for closing the pocket 22. The pocket 22 may also include a lining 46. A handle 24 may be secured to the body 16 for carrying or otherwise supporting the jacket 10. The handle 24 may include decorative indicia such as beads 48. The exterior surface 20 of the body 16 may include a decorative or textured surface cover 26 or layer and ornamentation 28. The surface cover 26 or the ornamentation 28 may give the jacket 10 the outward appearance of a wrapped greeting.

Still referring now to FIGS. 5-7, the jacket 10 may be formed from a one-piece substrate of a semi-rigid material, such as cardboard, card or heavy stock paper. The body 16 of the jacket 10 may include a generally rectangular shaped main panel 31 folded such that the body 16 may have generally elongated, triangular shape. Further, the main panel 31 may be folded to create a front wall 36, a base 50 and a back wall 52. A first 54 and a second 56 gusseted side panel may extend from the main panel 31 and may be folded to create, with the main panel 31, the pocket 22. The flap 24 may extend from the main panel 31.

Still referring to FIGS. 5-7 and as best shown in FIG. 6, a fastener 37, such as a snap, VELCRO®, button, slot and tab, or adhesive fastener may be positioned on an interior surface 38 of the flap 24 and to the front wall 36. Accordingly, the fastener 24 may operate to secure the flap 24 to the front wall 36 of the body 16 and enclose the pocket 22.

Still referring to FIGS. 5-7, the exterior surface 20 of the body 16 may be covered with a decorative or textured cover 24. For example, the body 16 by be covered with a textured or plain paper, a fabric, stickers or decals, or may be painted. Further, one or more items of ornamentation 28 such as a ribbon, bow or artificial flower may be positioned on the exterior surface 20 such that the jacket 10 assumes the outward appearance of a wrapped greeting or present.

Having thus described my invention, various other embodiments will become known to those of skill in the art that do not depart from the scope of the present invention.

1. A greeting card jacket operable to contain a greeting card positioned in a pocket of a body of the jacket, the jacket comprising,
a body having an exterior surface, an interior surface that defines a pocket, a flap operable to enclose the pocket, a fastener operable to secure the flap in a closed position, and a handle, the exterior such including a covering and an ornamentation element, the cover and the ornamentation element operable to give the body the appearance of a wrapped gift.
a greeting card positioned in the pocket of the body of the jacket.

2. The greeting card jacket of claim 1, wherein the handle includes a plurality of beads.

3. The greeting card jacket of claim 1, wherein the fastener is selected from a group consisting of a snap, VELCRO®, a button, a slot and tab and an adhesive fastener.

4. The greeting card jacket of claim 1, wherein the cover is selected from a group consisting of a textured paper, a non-textured paper, a fabric, stickers, decals, and paint.

5. The greeting card jacket of claim 1, wherein the ornamentation element is selected from a group consisting of a ribbon, a bow and an artificial flower.

6. The greeting card jacket of claim 1, wherein the body comprises a rear panel and a first side, a second side panel and a front panel that extend from the rear panel, the side and a front panels operable to be folded relative to the rear panel to create the pocket.

7. The greeting card jacket of claim 1, wherein the body comprises an elongated body having a front wall, a base and a back wall.

8. A greeting card jacket comprising, in combination
a body having an exterior surface, an interior surface that defines a pocket, a flap operable to enclose the pocket, a fastener operable to secure the flap in a closed position, and a handle, the exterior such including a covering and an ornamentation element, the cover and the ornamentation element operable to give the body the appearance of a wrapped gift;
a greeting card positioned in the pocket of the body of the jacket; and
a stand operable to support the body.

9. The greeting card jacket of claim 8, wherein the handle includes a plurality of beads.

10. The greeting card jacket of claim 8, wherein the fastener is selected from a group consisting of a snap, VELCRO®, a button, a slot and tab and an adhesive fastener.

11. The greeting card jacket of claim 8, wherein the cover is selected from a group consisting of a textured paper, a non-textured paper, a fabric, stickers, decals, and paint.

12. The greeting card jacket of claim 8, wherein the ornamentation element is selected from a group consisting of a ribbon, a bow and an artificial flower.

13. The greeting card jacket of claim 8, wherein the body comprises a rear panel and a first side, a second side panel and a front panel that extend from the rear panel, the side and a front panels operable to be folded relative to the rear panel to create the pocket.
